(19) United States
(12) Patent Application Publication
(10) Pub. No.: US 2007/0097877 A1
(43) Pub. Date: May 3, 2007

(54) Distributing information over parallel network interfaces

(76) Inventors: G. J. Hoekstra, Amersfoort (NL); H. B. Meeuwissen, Huizen (Noord-Holland) (NL)

Correspondence Address: WILLIAMS, MORGAN & AMERSON, 10333 RICHMOND, SUITE 1100, HOUSTON, TX, 77042, US

(21) Appl. No.: 11/264,855

(22) Filed: Nov. 2, 2005

(51) Int. Cl. H04J 1/16; H04Q 7/24; H04J 3/22

(52) U.S. Cl. 370/252; 370/338; 370/235; 370/468

(57) ABSTRACT

The present invention provides a method for distributing information over parallel network interfaces. The method includes establishing a plurality of concurrent network connections using a plurality of network interfaces and determining a plurality of portions of information to be transmitted based on a plurality of data transfer rates associated with the plurality of concurrent network connections.

### BACKGROUND OF THE INVENTION

1. Field of the Invention

This invention relates generally to communication systems, and, more particularly, to wireless communication systems.

2. Description of the Related Art

Each terminal in a communication network includes one or more network interfaces, which may be used to form a network connection with one or more other terminals. Network connections form a logical association between connected terminals according to one or more communication protocols. For example, one network interface may operate according to a Universal Mobile Communications System (UMTS) protocol and a second network interface may operate according to an IEEE 802.11 protocol. The network connections between the terminals may be initiated and/or terminated on the network interface of the terminals. Although more than one network interface may be available to the terminals in the communication network, each terminal conventionally selects one network interface to establish the logical association between connected terminals. For example, two terminals may form a network connection using UMTS network interfaces if the expected quality of service is better than the expected quality of service for a network connection formed using an IEEE 802.11 network interface.

For example, FIG. 1 conceptually illustrates a communication network 100 including first and second terminals 105(1-2). The first terminal 105(1) may exchange information with the second terminal 105(2) over a first network connection 110, which terminates at the network interfaces 115(1-2) of the first and second terminals 105(1-2). Alternatively, the first terminal 105(1) may exchange information with the second terminal 105(2) over a second network connection 120, which terminates at the network interfaces 125(1-2) of the first and second terminals 105(1-2). The first and second terminals 105(1-2) each have a network address associated with their network interface 115(1-2). The first and second network connections 110, 120 may operate according to any desirable wired and/or wireless protocol, such as an Internet protocol, a Universal Mobile Communications System (UMTS) protocol, an IEEE 802.11 protocol, a Bluetooth protocol, and the like.

Bottlenecks may form in the communication network 100, at least in part because the first and second terminals 105(1-2) exchange information over either the first network connection 110 or the second network connection 120. For example, the first terminal 105(1) may need to receive a large amount of data from the second terminal 105(2) over the network connection 110. However, the data transfer rate may be limited by the throughput of one or both of the network interfaces 115(1-2), which may result in delays in receiving the data. For another example, multiple applications (not shown) in the terminals 105(1-2) may use a single network interface 115(1-2) to transmit and/or receive data over the network connection 110. Bottlenecks may then form as the multiple applications compete for capacity to receive and/or transmit data over the network connection 110. Many techniques have been proposed to increase the capacity of conventional wireless communication networks.

Throughput of the communication network 100 may be increased at the physical layer. Capacity may be increased by enhancing modulation schemes, media access control, and/or the transmission and/or reception capacity. For example, channel bonding has been used to increase the capacity of wireless local area networks. In channel bonding, multiple radiofrequency channels are combined to form a single logical channel with a higher capacity. For another example, multiple channels formed with the multiple antennas used in Multiple-Input-Multiple-Output (MIMO) systems may be combined to form one relatively large capacity channel. The single logical channel is administered by an associated network interface. Although combining channels to form a single channel may lead to large capacity gains, the physical circumstances must meet certain conditions. For example, MIMO systems perform well in a rich scattering environment, but may not perform as well in low scattering environments.

The capacity of the communication network 100 may also be increased by modifying one or more application layers. For example, peer-to-peer (P2P) programs, such as eDonkey and Kazaa, can download a file that has been divided into multiple file segments. The file segments may be downloaded from different servers in parallel over a single network interface. The file segments are then combined to restore the original file. The functionality for achieving the performance improvement resides at the application layer. Lower-level functional layers, such as the transport layer, operate as if multiple applications are receiving the file segments. However, application-level modifications may still be limited by the capacity of the network interface 115(1-2).

Modifications to a data link layer may also be used to increase capacity of the communication network 100. For example, MultiNet is virtualization architecture for wireless local area network cards that may enable a user to connect his or her machine to multiple wireless networks using a single wireless local area network card, i.e. a single network interface. In operation, MultiNet exposes multiple virtual adapters for each underlying wireless network card. A network hopping scheme then switches the wireless card across the desired wireless networks, each of which may provide a separate network stream. However, MultiNet may become unstable and oscillate between the network streams, at least in part because MultiNet maps a single transport session associated with a single network interface on to multiple network streams.

However, the proposed techniques for increasing the throughput of the communication network 100 are all limited by the conventional practice of selecting a single network interface for transmission and/or reception of information. Accordingly, the capacity associated with other network interfaces that may be available to the terminals 105(1-2) may be underutilized or completely wasted, which may reduce the throughput and/or the efficiency of the communication network 100.

### SUMMARY OF THE INVENTION

The present invention is directed to addressing the effects of one or more of the problems set forth above. The following presents a simplified summary of the invention in order to provide a basic understanding of some aspects of the invention. This summary is not an exhaustive overview of the invention. It is not intended to identify key or critical elements of the invention or to delineate the scope of the invention. Its sole purpose is to present some concepts in a simplified form as a prelude to the more detailed description that is discussed later.

In one embodiment of the present invention, methods are provided for distributing information over parallel network interfaces. The methods may include establishing a plurality of concurrent network connections using a plurality of network interfaces and determining a plurality of portions of information to be transmitted based on a plurality of data transfer rates associated with the plurality of concurrent network connections.

### BRIEF DESCRIPTION OF THE DRAWINGS

The invention may be understood by reference to the following description taken in conjunction with the accompanying drawings, in which like reference numerals identify like elements, and in which:

FIG. 1 conceptually illustrates a conventional communication network including first and second terminals;

FIG. 2 conceptually illustrates one exemplary embodiment of a wireless communications system, in accordance with the present invention;

FIGS. 3A, 3B, and 3C conceptually illustrate three exemplary embodiments of wireless communication systems that may allow one or more terminals to form one or more concurrent network connections via a plurality of network interfaces, in accordance with the present invention;

FIG. 4 conceptually illustrates one exemplary embodiment of a distribution server, in accordance with the present invention; and

FIG. 5 conceptually illustrates one exemplary embodiment of a plurality of concurrent network connections between two terminals, in accordance with the present invention.

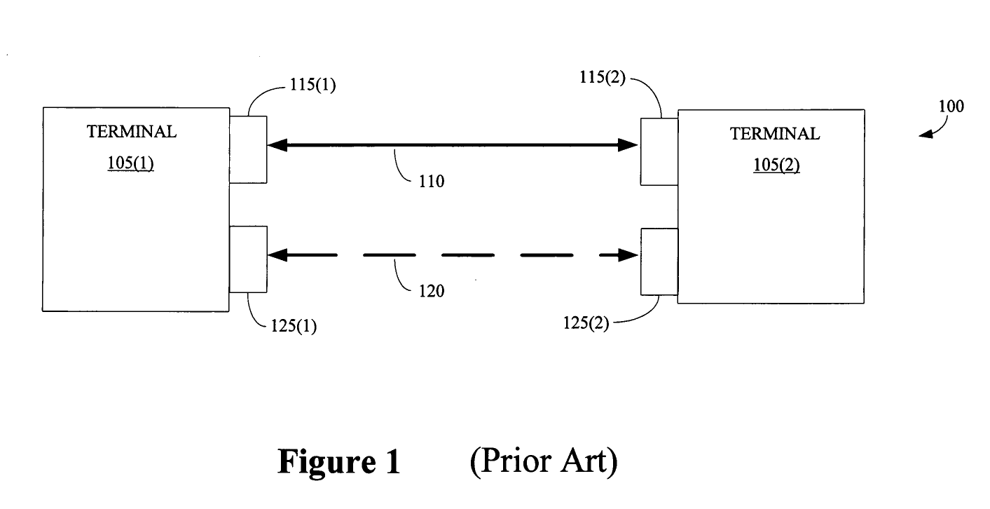

While the invention is susceptible to various modifications and alternative forms, specific embodiments thereof have been shown by way of example in the drawings and are herein described in detail. It should be understood, however, that the description herein of specific embodiments is not intended to limit the invention to the particular forms disclosed, but on the contrary, the intention is to cover all modifications, equivalents, and alternatives falling within the spirit and scope of the invention as defined by the appended claims.

### DETAILED DESCRIPTION OF SPECIFIC EMBODIMENTS

Illustrative embodiments of the invention are described below. In the interest of clarity, not all features of an actual implementation are described in this specification. It will of course be appreciated that in the development of any such actual embodiment, numerous implementation-specific decisions should be made to achieve the developers' specific goals, such as compliance with system-related and business-related constraints, which will vary from one implementation to another. Moreover, it will be appreciated that such a development effort might be complex and time-consuming, but would nevertheless be a routine undertaking for those of ordinary skill in the art having the benefit of this disclosure.

Portions of the present invention and corresponding detailed description are presented in terms of software, or algorithms and symbolic representations of operations on data bits within a computer memory. These descriptions and representations are the ones by which those of ordinary skill in the art effectively convey the substance of their work to others of ordinary skill in the art. An algorithm, as the term is used here, and as it is used generally, is conceived to be a self-consistent sequence of steps leading to a desired result. The steps are those requiring physical manipulations of physical quantities. Usually, though not necessarily, these quantities take the form of optical, electrical, or magnetic signals capable of being stored, transferred, combined, compared, and otherwise manipulated. It has proven convenient at times, principally for reasons of conmmon usage, to refer to these signals as bits, values, elements, symbols, characters, terms, numbers, or the like.

It should be borne in mind, however, that all of these and similar terms are to be associated with the appropriate physical quantities and are merely convenient labels applied to these quantities. Unless specifically stated otherwise, or as is apparent from the discussion, terms such as “processing” or “computing” or “calculating” or “determining” or “displaying” or the like, refer to the action and processes of a computer system, or similar electronic computing device, that manipulates and transforms data represented as physical, electronic quantities within the computer system's registers and memories into other data similarly represented as physical quantities within the computer system memories or registers or other such information storage, transmission or display devices.

Note also that the software implemented aspects of the invention are typically encoded on some form of program storage medium or implemented over some type of transmission medium. The program storage medium may be magnetic (e.g., a floppy disk or a hard drive) or optical (e.g., a compact disk read only memory, or “CD ROM”), and may be read only or random access. Similarly, the transmission medium may be twisted wire pairs, coaxial cable, optical fiber, or some other suitable transmission medium known to the art. The invention is not limited by these aspects of any given implementation.

The present invention will now be described with reference to the attached figures. Various structures, systems and devices are schematically depicted in the drawings for purposes of explanation only and so as to not obscure the present invention with details that are well known to those skilled in the art. Nevertheless, the attached drawings are included to describe and explain illustrative examples of the present invention. The words and phrases used herein should be understood and interpreted to have a meaning consistent with the understanding of those words and phrases by those skilled in the relevant art. No special definition of a term or phrase, i.e., a definition that is different from the ordinary and customary meaning as understood by those skilled in the art, is intended to be implied by consistent usage of the term or phrase herein. To the extent that a term or phrase is intended to have a special meaning, i.e., a meaning other than that understood by skilled artisans, such a special definition will be expressly set forth in the specification in a definitional manner that directly and unequivocally provides the special definition for the term or phrase.

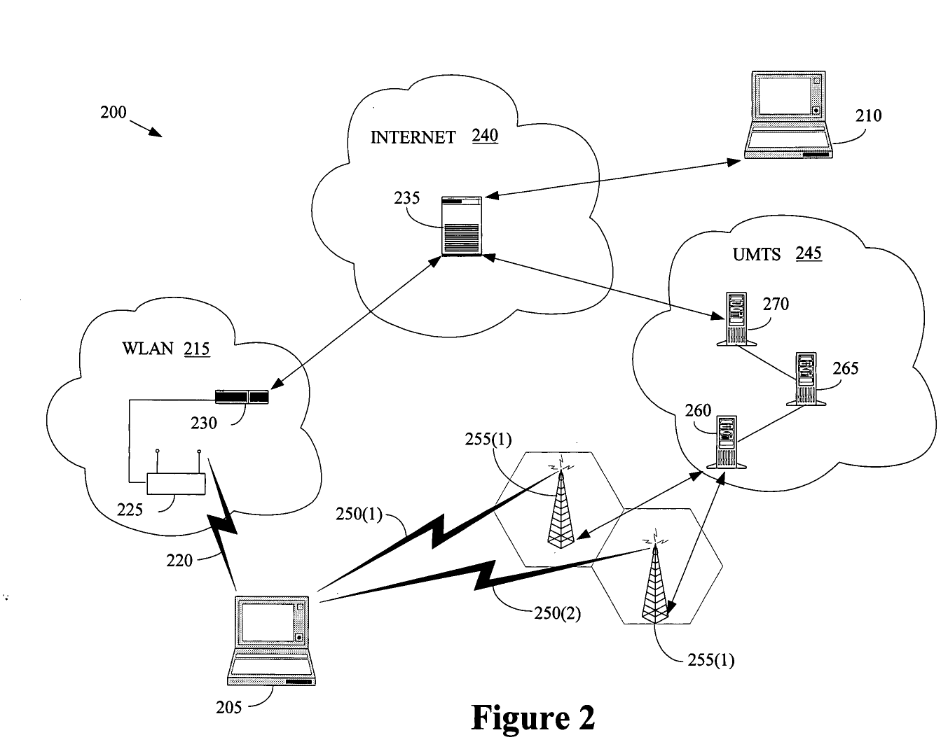

Referring now to FIG. 2, one exemplary embodiment of a wireless communications system 200 is shown. Although the present invention will be described in the context of the wireless communications system 200, persons of ordinary skill in the art having benefit of the present disclosure should appreciate that the present invention is not limited to wireless communications systems. In alternative embodiments, the present invention may be implemented in wired communications systems or systems that include a combination of wired and wireless technologies.

In the illustrated embodiment, the wireless communication system 200 may be used to form a network connection between terminals 205, 210. The terminals 205, 210 may be any desirable device capable of exchanging information via the wireless communication system 200. Exemplary terminals 205, 210 include, but are not limited to, mobile phones, personal data assistants, text messaging devices, paging devices, laptop computers, desktop computers, and the like. As used herein, the term “terminal” refers to any device that terminates a network connection. Accordingly, the terminals 205, 210 may also include devices such as access points, base stations, node-Bs, servers, network controllers, and the like. In various embodiments, the wireless communication system 200 may include any desirable number of terminals 205, 210.

The terminal 205 includes a plurality of network interfaces (not shown in FIG. 2). As used herein, the term “network interface” refers to the software and/or hardware used to define one or more network primitives that enable the terminal 205 to communicate over a particular network using a specific network technology. For example, network interfaces may be used to define network primitives for communication over a local area network (LAN), a wireless local area network (WLAN), a HiperLAN, a Universal Mobile Communication System (UMTS) network, a Global System for Mobile communications (GSM) network, and the like. The network interface enables communication between devices, such as the terminal 205, via the associated network(s). The network interface may use network protocols to route packets from source to destination, and different network interfaces may utilize different network protocols. Accordingly, in some embodiments, a converter (not shown) that transforms the protocol information may be used to realize end-to-end network layer communication. The network interface also terminates the associated network technology and converts lower layer information and associated data to a form that may be used by higher layers. For example, a network interface may convert physical layer information and associated data to transport and/or application layer information using a data link layer. In some embodiments, the network interface may include one or more physical interfaces (e.g. an antenna and/or a connector), as well as one or more data link layer protocols, which may transform information into physical signals (and vice versa) that appear free of transmission errors. The terminal 210 also includes one or more network interfaces.

The plurality of network interfaces in the terminal 205 enables the terminal 205 to form one or more network connections with a distribution server 235 using one or more networks. In the illustrated embodiment, the terminal 205 includes at least one network interface that enables the terminal 205 to communicate with a wireless local area network (WLAN) 215 via an air interface 220. The air interface 220 may operate according to any desirable protocol including, but not limited to, a Bluetooth protocol and/or an IEEE 802.11 protocol. Accordingly, the terminal 205 may communicate with an access point 225 that may be connected to a router 230. The router 230 may provide a communication link to the distribution server 235 in a wired and/or wireless network such as an Internet 240.

The terminal 205 may also include one or more network interfaces that enable the terminal 205 to communicate with a Universal Mobile Communication System (UMTS) network 245. In the illustrated embodiment, the terminal 205 includes a plurality of network interfaces that enable the terminal 205 to form one or more air interfaces 250(1-2) with one or more node-Bs or base stations 255(1-2). One or more of the base stations 255(1-2) may then communicate with a radio network controller 260, which may communicate with the distribution server 235 in the Internet 240 via a Gateway General Packet Radio Service (GPRS) Support Node (GGSN) 270 and a Serving GPRS Support Node (SGSN) 265. In one embodiment, the UMTS network 245 may implement a High Speed Downlink Packet Access (HSDPA) protocol and/or a High Speed Uplink Packet Access (HSUPA) protocol.

Although the wireless communication system 200 shown in FIG. 2 includes a wireless local area network 215 and a UMTS network 245 in communication with the Internet 240, persons of ordinary skill in the art should appreciate that the present invention is not limited to this specific embodiment. In alternative embodiments, the wireless communication system 200 may include more or fewer networks of any desirable type. For example, the wireless communication system 200 may only include the UMTS network 245, in which case the terminal 205 may include a plurality of network interfaces for communicating with the UMTS network 245 over a plurality of communication channels. For another example, the wireless communication system 200 may include additional wired and/or wireless networks, such as an Internet, one or more intranets, a Global System for Mobile communications (GSM) network, a Public Data Network (PDN), an IEEE 802.11 network, a Bluetooth network, and the like.

The terminal 205 is capable of using the plurality of network interfaces to establish one or more concurrent network connections using more than one of the network interfaces. For example, the terminal 205 may use a WLAN network interface and a UMTS network interface to form concurrent network connections to the distribution server 235 over the air interface 220 and the air interface 250(1). For another example, the terminal 205 may use multiple UMTS network interfaces (or multiple instances of a UMTS network interface) to form concurrent network connections to the distribution server 235 over the air interfaces 250(1-2). In one embodiment, the multiple network interfaces may be used for both uplink and downlink communications. However, in alternative embodiments, a dedicated transmission network interface may be used for uplink communications and a dedicated reception network interface may be used for downlink communications. Persons of ordinary skill in the art having benefit of the present disclosure should appreciate that the number and/or type of network interfaces used to form the network connections, as well as the partitioning of uplink and/or downlink communications, are matters of design choice. Moreover, the number and/or type of network interfaces used to form the network connections, as well as the partitioning of the uplink and/or downlink communications, may vary during operation of the wireless communication network 200.

In one embodiment, the distribution server 235 may also form one or more network connections to the terminal 210 to permit the terminal 205 to communicate with the terminal 210. For example, if the terminal 210 includes a plurality of network interfaces, the distribution server 235 may form a plurality of concurrent network connections with the network interfaces associated with the terminal 210. However, persons of ordinary skill in the art should appreciate that the present invention is not limited to forming a plurality of network connections. In alternative embodiments, the distribution server 235 may form a single network connection to the terminal 210.

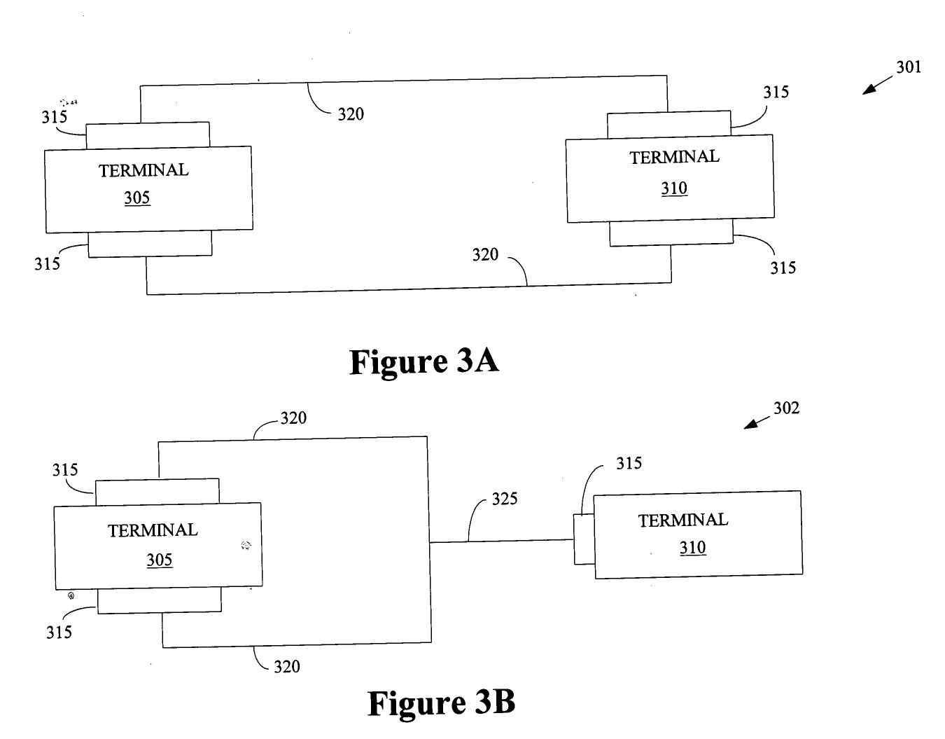

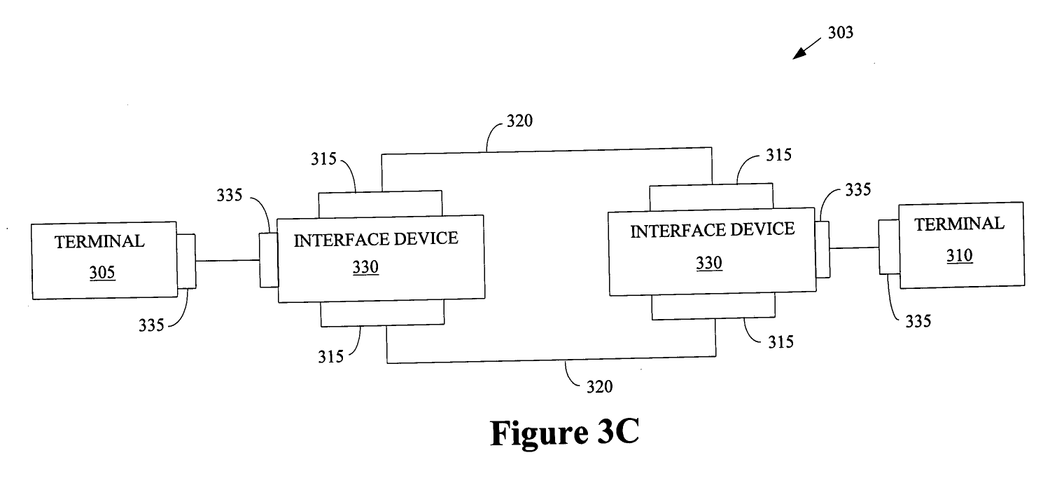

FIGS. 3A, 3B, and 3C conceptually illustrate three exemplary embodiments of wireless communication systems 301, 302, 303 that may allow one or more terminals to form one or more concurrent network connections via a plurality of network interfaces. In the interest of clarity, only two network connections will be shown in the exemplary embodiments of the wireless communication systems 301, 302, 303. However, persons of ordinary skill in the art having benefit of the present disclosure should appreciate that alternative embodiments of the present invention may include more than two network connections.

FIG. 3A conceptually illustrates the first exemplary embodiment of the wireless communication system 301. In the illustrated embodiment, the wireless communication system 301 includes two terminals 305, 310. Each of the terminals 305, 310 includes two network interfaces 315, which may be used to form two concurrent network connections 320 between the terminals 305, 310.

FIG. 3B conceptually illustrates the second exemplary embodiment of the wireless communication system 302. In the illustrated embodiment, the wireless communication system 302 includes two terminals 305, 310. The terminal 305 includes two network interfaces 315 and the terminal 310 includes a single network interface 315. Accordingly, two network connections 320 may be used to provide one or more concurrent network connections to a higher layer (such as an application layer) in the terminal 305. The traffic associated with the two network connections 320 may then be routed over a single communication link 325 by intermediate entities (not shown) in the wireless communication system 302.

FIG. 3C conceptually illustrates the third exemplary embodiment of the wireless communication system 303. In the illustrated embodiment, the wireless communication system 303 includes two terminals 305, 310 that are coupled to interface devices 330 via interfaces 335. The interface devices 330 each include two network interfaces 315, which may be used to form concurrent network connections 320. Information that is transmitted and/or received over the one or more network interfaces may be provided to a higher layer (such as an application layer) in the terminals 305, 310 via the interfaces 335.

Referring back to FIG. 2, information may be transmitted to (or received from) the terminal 205 over one or more concurrent network connections formed using one or more of the available network interfaces, as discussed above. Thus, the distribution server 235 may be configured to determine a plurality of portions of the information that should be transmitted over each of the one or more concurrent network connections using the associated network interfaces. Although the distribution server 235 is depicted as a part of the Internet 240, the present invention is not so limited. In alternative embodiments, one or more distribution servers 235 may be deployed at any distribution point (or plurality of distribution points) in the wireless communication system 200. Furthermore, the distribution server 235 may not be implemented in a single device so that portions of the distribution server 235 may be deployed at more than one location within the wireless communication system 200.

In one embodiment, the distribution server 235 may determine the sizes of the portions of the information for each of the concurrent network connections based on one or more data transfer rates associated with each of the concurrent network connections. For example, the distribution server 235 may determine that a WLAN network interface having a data transfer rate of approximately 50 Mbps should be used to transmit a first (relatively large) portion of the information and a UMTS network interface having a data transfer rate of approximately 100 kbps should be used to transmit a second (relatively small) portion of the information. For another example, the distribution server 235 may determine that a UMTS network interface for a relatively high quality-of-service network connection having a data transfer rate of approximately 100 kbps should be used to transmit a first (relatively large) portion of the information and a UMTS network interface for a relatively low quality-of-service network connection having a data transfer rate of approximately 10 kbps should be used to transmit a second (relatively small) portion of the information. Persons of ordinary skill in the art should appreciate that other criteria not discussed above may also be used to determine the portions of the information to be transmitted over each network connection.

The distribution server 235 may determine or adjust the sizes of the portions of the information for each of the concurrent network connections before and/or during the lifetimes of the network connections, i.e. the distribution server 235 may determine or adjust the sizes of the portions dynamically. Furthermore, the distribution server 235 may add and/or remove concurrent network connections at any time. For example, one or more networks may become available or visible as the terminal 205 roams. Currently available or visible networks may also disappear as the terminal 205 roams. The distribution server 235 may therefore allocate portions of information to newly added network connections and de-allocate portions of information that were allocated to network connections that have become unavailable. Accordingly, the distribution server 235 may enable seamless roaming by the terminal 205.

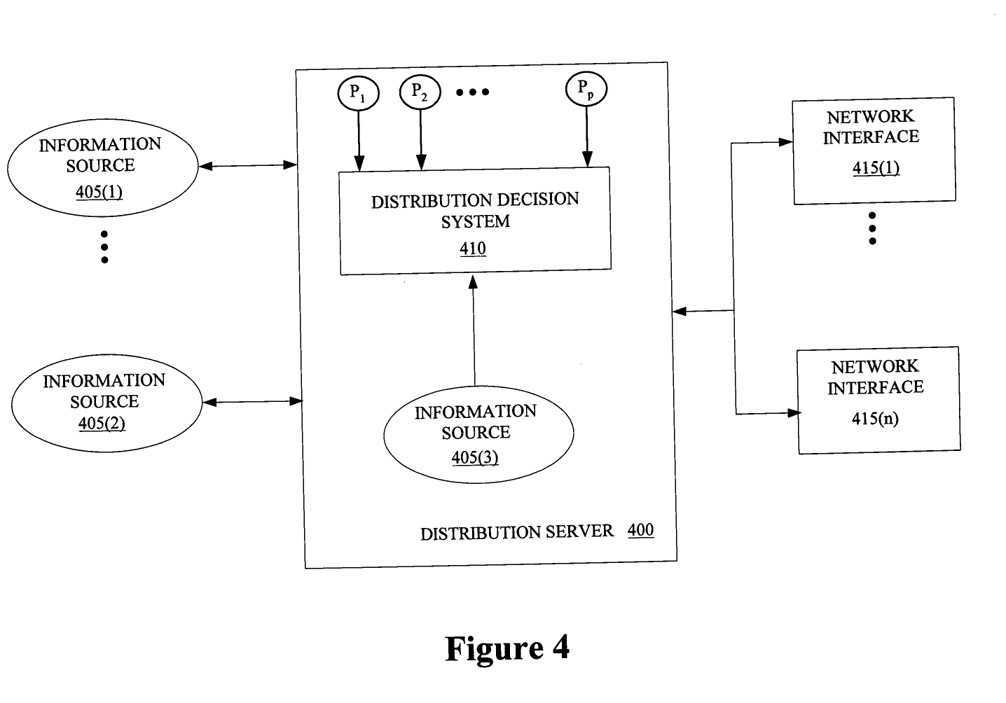

FIG. 4 conceptually illustrates one exemplary embodiment of a distribution server 400. In the illustrated embodiment, the distribution server 400 may receive and/or access information from one or more information sources 405(1-3). The distribution server 400 may also provide information to one or more of the information sources 405(1-3). As used herein, the term “information source” will be understood to refer to entities that may generate or contains information that is to be delivered to the distribution server 400, which may then provide this information to another entity. The information sources 405(1-2) may be external to the distribution server 400. For example, the information source 405(1) may be a terminal such as a mobile telephone, a personal data assistant, a smart phone, a text messaging device, a wireless card, a laptop, the desktop, and the like. For another example, the information source 405(2) may be a server such as an electronic mail server, a file server, and the like. In one embodiment, one or more of the information sources 405(3) may be implemented as a portion of the distribution server 400. For example, the distribution server 400 may include a file system to host information that may be transmitted.

The distribution server 400 includes a distribution decision system 410, which is configured to determine how information should be exchanged with a multi-interface connection endpoint (not shown in FIG. 4) using one or more concurrent network connections formed by one or more network interfaces 415(1-n). In the illustrated embodiment, the distribution decision system 410 may determine a distribution of the information to be transmitted over the network interfaces 415(1-n) based on a set of p input parameters (Pₗ-Pₚ). As used herein, the term “input parameter” will be understood to refer to parameters that deliver information that the distribution decision system 410 may use to determine whether a network connection is active (or should be activated) and how the data may be distributed over these network connections. In one embodiment, the input parameters may also be used to determine whether a network connection is idle or inactive, as well as whether the network connection should be de-activated. Persons of ordinary skill in the art having benefit of the present disclosure should appreciate that the number of input parameters, as well as the particular form of the information conveyed by these parameters, is a matter of design choice and not material to the present invention.

In one embodiment, the input parameters (Pₗ-P_{P}) include basic input, which may also be referred to as configuration input. The basic input may include a basic set of input parameters that characterize the operational environment of the distribution decision system 410 and may form a fundamental source of input. For example, the basic input to the distribution decision system 410 may include information indicating how the distribution decision system 410 controls the information exchange with multi-interface connection endpoints, the number of network interfaces 415(1-n) and one or more characteristics of the network interfaces 415(1-n) that may be used for the distributed information exchange, and, if present, how different network interfaces 415(1-n) are addressed. The distribution decision system 410 may also access or receive internal input such as transport session information. Internal input may be directly used by the distribution decision system 410 because the internal input can be retrieved from distribution decision system 410 variables. For example, the internal input may include information indicating progress of existing transport sessions, the number of existing transport sessions, and the like.

The distribution decision system 410 may also access or receive external input. The external input may include input provided to (or accessed by) the distribution decision system 410 based on functionality external to the distribution decision system 410 in the same network element (e.g. other protocol layer information, the amount of information remaining to be transferred, and the like) or another element (e.g. the multi-interface connection endpoint). The external input may also include information related to the information source(s). In one embodiment, external input may be provided by, or formed based on, lower layer input. For example, parameters obtained from lower protocol layers may be used to avoid optimizations on different layers that may take counteractive measures. One source for lower layer input may be the physical transmit/receive devices, which may provide the distribution decision system 410 with information indicating whether associated antenna systems operate in MIMO mode. The physical transmit/receive devices may also provide the distribution decision system 410 with information indicating one or more Signal-to-Noise ratios associated with one or more received signals. In some alternative embodiments, the external input may include context information. For example, the external input may include one or more parameters related to the context of one of the involved elements in a communications scenario that may enforce specific behavior at the distribution decision system 410. In one embodiment, the external input may also include information provided by the distribution server 400, such as information associated with (or determined based on information associated with) one or more transport sessions.

The distribution decision system 410 may also access or receive management and/or policy input. In one embodiment, input parameters may be provided by management system policies, such as policies that may enforce specific strategies to be applied. Exemplary policies and/or strategies may include preferred network usage or avoidance, limitations to the number of connections, bounds for the maximum throughput to be used, aiming for reliability (e.g., by duplication of information) or throughput performance, and thresholds on the minimum data transfer rate per interface (e.g., for enabling seamless roaming). In alternative embodiments, the management and/or policy input may be provided to the distribution decision system 410 by any portion of the communication system.

The distribution decision system 410 may select portions of the information to be transmitted by one or more associated network interfaces 415(1-n). The selection may be based in part on one or more of the input variables discussed above. In one embodiment, the distribution decision system 410 configures the distribution server 400 to distribute information to the network interfaces 415(1-n) so that the information may be transmitted in a minimum total transfer time. For example, the distribution decision system 410 may provide information that may be used by the distribution server 400 to distribute information to the network interfaces 415(1-n) so that the available network interfaces 415(1-n) are used concurrently until the information is transferred. For example, the distribution server 400 may distribute information to the network interfaces 415(1-n) so that the network interfaces 415(1-n) begin transmitting information at approximately the same time and finish transferring information at approximately the same time. However, persons of ordinary skill in the art having benefit of the present disclosure should appreciate that many factors may influence of the starting and/or finishing time for the transfer of information by each of the network interfaces 415(1-n), and so in practice it may be difficult or impossible to guarantee that the network interfaces 415(1-n) begin transmitting information at the same time and finish transferring information at the same time.

In some embodiments, the distribution decision system 410 may decide to duplicate the information to be transferred, especially in unreliable environments. The distribution decision system 410 may also take into account the fact that interfaces may discontinue or join communications, either at the current time or in the future. Furthermore, the distribution decision system 410 may use the input parameters (Pₗ-Pₚ) to select portions of the information to be transmitted by one or more associated network interfaces 415(1-n). As discussed above, the distribution server 400 may include an internal information source 405(3), such as a file system. If the distribution server 400 is integrated with a file system that hosts the information to be transferred, the distribution decision system 410 may determine how to split-up the files that are to be transferred into fragments that are sent over one or more of the available interfaces 415(1-n).

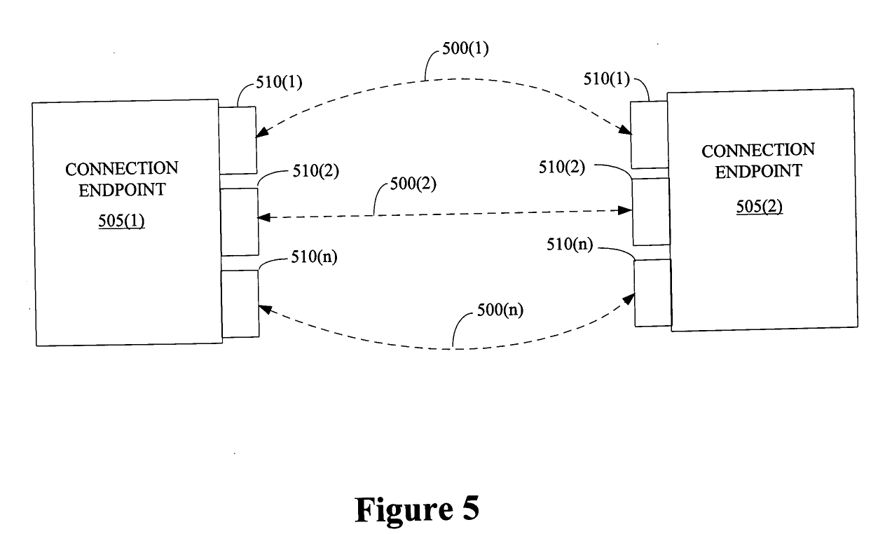

FIG. 5 conceptually illustrates one exemplary embodiment of a plurality of concurrent network connections 500(1-n) between two terminals 505(1-2). The terminals 505(1-2) may also be referred to hereinafter as connection endpoints 505(1-2). Each terminal or connection endpoint 505(1-2) may include a plurality of network interfaces 510(1-n). However, persons of ordinary skill in the art having benefit of the present disclosure should appreciate that each connection endpoint 505(1-2) may include more or fewer network interfaces 510(1-n) for establishing more or fewer concurrent network connections 500(1-n). Moreover, the number of network interfaces 510(1-n) may not always be the same as the number of concurrent network connections 500(1-n). For example, management policies may indicate that one or more network interfaces 510(1-n) should not be used to establish concurrent network connections.

In the illustrated embodiment, the connection endpoint 505(2) intends to transfer an amount of information equal to m (measured, for example, in bits) towards the connection endpoint 505(1). The information may then be distributed over the network interfaces 510(1-n) according to the following algorithm. In the following discussion, the network interfaces 510(1-n) may be referred to as iₗ, . . . , iₙ, respectively. The network interfaces 510(1-n) have corresponding transfer rates sₗ, . . . , sₙ, which may be measured, for example, in bits per second. An information distribution ratio, FRᵢ, of information to be transferred through interface iᵢ may be defined using the formula:

$${FR}_{i} = \frac{{s}_{i}}{{\sum }_{j = 1}^{n} {s}_{j}}$$

In this embodiment, the amount of information sent via the interface iᵢ equals m times the value of the FRᵢ ratio.

A download time to transfer information equal to m times FRᵢ through interface iᵢ, Dtᵢ, may be defined as:

$$\begin{matrix}D {t}_{i} = \frac{m \cdot \frac{{s}_{i}}{{\sum }_{j = 1}^{n} {s}_{j}}}{{s}_{i}} \\ D {t}_{i} = \frac{m}{{\sum }_{j = 1}^{n} {s}_{j}}\end{matrix}$$

or, equivalently:
In this embodiment of the distribution algorithm, Dtᵢ is independent of i and equals the total time required to transfer m bit over all interfaces simultaneously.

The information distribution ratio, FRᵢ, may be determined (or re-determined) at any time. In various alternative embodiments, the information distribution ratio, FRᵢ, may be determined (or re-determined) substantially continuously or at selected intervals, e.g. periodically with a predetermined periodicity. The information distribution ratio, FRᵢ, may also be determined (or re-determined) in response to selected events. For example, the distribution decision system 410 shown in FIG. 4 may determine (or re-determine) the information distribution ratio, FRᵢ, when triggered by changes in the input parameters. Other examples of events may include a data transfer rate change, a packet arrival, a packet loss, a network interface that becomes available or disappears, a network connection that is stopped, terminated or aborted, and a measured degradation of a signal. Accordingly, values of Dtᵢ may be varied to account for changing circumstances.

In some embodiments, the values of the data transfer rates sₗ, . . . , sₙ, may be unknown in advance (or be changing for example due to roaming). In that case, the best estimates of sₗ, . . . , sₙ, may be used to compute the initial distribution ratios FRᵢ for all n interfaces, and the information may be distributed accordingly. The values of the distribution ratios, FRᵢ, may then be updated using the input parameters, Pₗ . . . Pₚ to enable optimal distribution of the information. When n is changing, the values of the distribution ratios FRᵢ for the remaining or available interfaces may be recomputed so that the information can be re-distributed accordingly. For example, when one or more of the connection endpoints 505(1-2) are roaming, n may change, which may indicate newly available networks or networks that are no longer available. If the value of m is known or can be estimated, the total download time may be estimated or determined.

In one embodiment, thresholds for using certain network interfaces may be set and/or maintained. A particular interface may be selected for use by setting thresholds that correspond to one or more minimum values of FRᵢ. In one embodiment, the minimum (or threshold) value of FRᵢ corresponds to a threshold value of the data transfer rate, sᵢ. For example, the network interface 510(1) may not be used when the data transfer rate sₗ<10 kbps, where 10 kbps is an operational threshold set for the network interface 510(1). In the case of having very small values of sᵢ, duplicate information may be transmitted over the network interfaces 505(1-n), at least in part because small values of sᵢ may indicate unreliable connections.

The particular embodiments disclosed above are illustrative only, as the invention may be modified and practiced in different but equivalent manners apparent to those skilled in the art having the benefit of the teachings herein. Furthermore, no limitations are intended to the details of construction or design herein shown, other than as described in the claims below. It is therefore evident that the particular embodiments disclosed above may be altered or modified and all such variations are considered within the scope and spirit of the invention. Accordingly, the protection sought herein is as set forth in the claims below.

What is claimed:

1. A method involving a plurality of concurrent network connections using a plurality of network interfaces, comprising:
determining a plurality of portions of information to be transmitted based on a plurality of data transfer rates associated with the plurality of concurrent network connections.

2. The method of claim 1, comprising establishing the plurality of concurrent network connections, wherein establishing the plurality of concurrent network connections comprises establishing the plurality of concurrent network connections according to at least one of a Universal Mobile Communication System (UMTS) protocol, a Global System for Mobile communication (GSM) protocol, a Code Division Multiple Access (CDMA, CDMA 2000) protocol, an IEEE 802 protocol, a Bluetooth protocol, a High Speed Downlink Packet Access protocol, a High Speed Uplink Packet Access protocol, and a HiperLAN protocol.

3. The method of claim 1, wherein determining the plurality of portions of information to be transmitted comprises determining the plurality of portions of information to be transmitted at selected time intervals or substantially continuously.

4. The method of claim 3, comprising selecting the time intervals for determining a plurality of portions of information to be transmitted.

5. The method of claim 4, wherein selecting the time intervals comprises selecting the time intervals based on at least one of a predetermined periodicity, a data transfer rate change, a packet arrival, a packet loss, a network interface that becomes available or disappears, a network connection that is stopped, terminated or aborted, and a measured degradation of a signal.

6. The method of claim 1, wherein determining the plurality of portions of information to be transmitted comprises determining the plurality of portions of information to be transmitted so that the plurality of portions of information complete transmission over the associated network connections at approximately the same time.

7. The method of claim 1, comprising determining at least one data transfer rate associated with at least one of the plurality of network connections.

8. The method of claim 7, wherein determining said at least one data transfer rate comprises determining said at least one data transfer rate based on feedback information provided over the associated network connection.

9. The method of claim 1, comprising determining the plurality of portions of information to be transmitted based upon at least one parameter associated with at least one of the plurality of network interfaces.

10. The method of claim 9, wherein determining the plurality of portions of information to be transmitted based upon said at least one parameter comprises determining the plurality of portions of information to be transmitted based upon at least one of a number of network interfaces, a characteristic of one of the network interfaces, an addressing scheme associated with one of the network interfaces, a number of transport sessions, an amount of information waiting to be transmitted, progress of one of the transport sessions, lower layer protocol information, context information, and management or policy information.

11. The method of claim 1, comprising determining at least one threshold associated with at least one of the plurality of network interfaces based on at least one of the plurality of data transfer rates.

12. The method of claim 1, comprising accessing the information to be transmitted.

13. The method of claim 1, comprising transmitting the plurality of portions of the information over the corresponding plurality of concurrent network connections.

14. A method involving a plurality of concurrent network connections using a plurality of network interfaces, comprising:
receiving a plurality of portions of information over the plurality of concurrent network connections, the plurality of portions of information being determined based on a plurality of data transfer rates associated with the plurality of concurrent network connections.

15. The method of claim 14, wherein receiving the plurality of portions of information over the plurality of concurrent network connections comprises receiving the plurality of portions of information, the portions being determined so that reception of the plurality of portions of information over the associated network connections is completed at approximately the same time.

16. The method of claim 14, comprising providing feedback information over at least one of the plurality of network connections.

17. The method of claim 16, wherein providing feedback information comprises providing feedback information that may be used to determine at least one of the plurality of data transfer rates.
